(19) United States
(12) Patent Application Publication
(10) Pub. No.: US 2015/0183676 A1
(43) Pub. Date: Jul. 2, 2015

(54) METHOD FOR PRODUCING CYLINDERS OF QUARTZ GLASS

(71) Applicant: Heraeus Quarzglas GmbH & Co. KG, Hanau (DE)

(72) Inventors: Martin Trommer, Bitterfeld (DE); Klaus-Uwe Badeke, Petersberg-Sennewitz (DE)

(21) Appl. No.: 14/412,068

(22) PCT Filed: Jul. 2, 2013
(86) PCT No.: PCT/EP2013/063924

§ 371 Date: Dec. 30, 2014

(30) Foreign Application Priority Data
Jul. 3, 2012 (DE) 10 2012 013 134.8

(51) Int. Cl. C03B 19/14

(52) U.S. Cl. CPC C03B 19/1415; C03B 2201/02; C03B 2207/52; C03B 2207/70; C03B 2207/66

(57) ABSTRACT

A method for producing quartz glass cylinders includes producing soot bodies using depositing burners to deposit SiO₂ particles for mass deposition on a rotating substrate and vitrifying the soot bodies to form quartz glass cylinders. Prior to producing the soot bodies, the following steps are carried out: producing first and second test soot bodies, determining the density distribution of the first test soot body in the axial direction; vitrifying the second test soot body to generate a test quartz glass cylinder; determining the mass distribution of the test quartz glass cylinder in the axial direction; and setting the mass deposition of SiO₂ particles to be deposited as a function of the axial mass distribution of the test quartz glass cylinder. As such, the mass distribution of the produced and vitrified soot bodies is improved and/or made more homogeneous relative to the axial mass distribution of the test quartz glass cylinder.

### CROSS-REFERENCE TO RELATED APPLICATIONS

This application is a Section 371 of International Application No. PCT/EP2013/063924, filed Jul. 2, 2013, which was published in the German language on Jan. 9, 2014, under International Publication No. WO 2014/006037 A1 and the disclosure of which is incorporated herein by reference.

### BACKGROUND OF THE INVENTION

The present invention relates to a method for producing cylinders made of quartz glass.

In a known method for producing cylinders made of quartz glass, soot bodies are produced, whereby at least two depositing burners are used to deposit SiO₂ particles for depositing mass on a substrate that rotates about its longitudinal axis. The soot bodies are then vitrified while forming quartz glass cylinders. The SiO₂ particles can be deposited on the outside of the rotating substrate. For this reason, this method is called outside deposition method.

A soot body is a body that is produced in a so-called “soot method”. In a soot method, the temperature is selected to be sufficiently low during the deposition of the SiO₂ particles, such that a porous soot body is generated, which is then sintered to form quartz glass in a separate procedural step. In contrast to the soot method, the temperature in direct vitrification is selected to be sufficiently high for the SiO₂ particles to be vitrified directly during deposition on the substrate surface.

Common outside deposition methods include the OVD method (outside vapor deposition), VAD method (vapor phase axial deposition) or the PECVD method (plasma-enhanced chemical vapor deposition).

In the OVD method, the at least two depositing burners are preferably arranged to be next to each other in an axial direction and can be moved back and forth in the axial direction during the deposition of the SiO₂ particles.

However, the methods currently known are disadvantageous in that the external surface of the quartz glass cylinders produced is uneven; i.e., the external diameter of the quartz glass cylinder shows great variation in the axial direction. However, since the aim is to produce a quartz glass cylinder with an even diameter in theaxial direction, the quartz glass cylinder produced is usually post-processed by polishing the surface. The polishing leads to a relatively large loss of material.

It is therefore one objective of the present invention to devise a method for producing cylinders made of quartz glass, in which the external diameter in the axial direction is as constant as possible and in which material can thus be saved during the production of cylinders made of quartz glass.

### BRIEF SUMMARY OF THE INVENTION

One embodiment of the present invention advantageously provides a method for producing cylinders made of quartz glass comprising the following steps: producing soot bodies using at least two depositing burners to deposit SiO₂ particles for mass deposition on a substrate that rotates about its longitudinal axis; vitrifying the soot bodies to form quartz glass cylinders; and, prior to producing and vitrifying the soot bodies, carrying out the following steps: a) producing a first test soot body using the at least two depositing burners to deposit SiO₂ particles for mass deposition on a substrate that rotates about its longitudinal axis; b) determining the density distribution of the first test soot body in an axial direction; c) producing a second test soot body, wherein the axial density distribution of the second test soot body is set, preferably is made more homogeneous, as a function of the axial density distribution of the first test soot body as determined; d) vitrifying the second test soot body such that a test quartz glass cylinder is generated; e) determining the mass distribution of the test quartz glass cylinder in the axial direction; and f) setting the mass deposition of SiO₂ particles to be deposited on the substrate by the depositing burners as a function of the axial mass distribution of the test quartz glass cylinder as determined in such manner that the mass distribution of vitrified soot bodies produced by the depositing burners is improved and/or made more homogeneous with respect to the axial mass distribution of the test quartz glass cylinder.

In one aspect, the present invention is advantageous in that the method for producing quartz glass cylinders is first optimized through the iterative method comprising procedural steps a)-f) before actually producing the quartz glass cylinders, such that the quartz glass cylinders produced using an optimized method of this type have an external diameter in the axial direction that is as constant as possible. This allows material to be saved, since the quartz glass cylinders produced using the optimized method do not need to be polished at all or only little.

An inhomogeneity in the density of the soot body during the production of cylinders made of quartz glass may lead to a difference in shrinking behavior during the vitrification process and this, in turn, affects the external geometry of the quartz glass cylinder thus produced. Moreover, the vitrification may be associated with a change in mass distribution.

A change in mass distribution during vitrification occurs, in particular, if the soot body is arranged in vertical direction during vitrification. One advantage of embodiments of the present invention is that the density distribution of the test soot body in the axial direction is taken into consideration. Another advantage of embodiments of the present invention is that the mass distribution of the test quartz glass cylinder in the axial direction is determined after vitrification, rather than just the mass distribution of the test soot body before vitrification.

According to procedural step c), the axial density distribution of the second test soot body is being set, preferably is made more homogeneous. The axial density distribution of the second test soot body is preferably made more homogeneous if the density variation of the second test soot body in the axial direction is preferably less than +/−8.0% of the mean density of the second test soot body. This means that the density of the second test soot body in the axial direction varies by less than +/−8.0% of the mean density of the second test soot body. Any reference being made to second soot body shall refer only to the region of the soot body that is cylindrical and corresponds to the usable region. For production reasons, the soot body tapers at the ends of the soot body. These regions are called end caps. The end caps are not taken into consideration in the determination and setting of the density variation and mean density.

The mean density of the second test soot body usually corresponds to 22-35% of the density of quartz glass. Provided the mean density of the second test soot body corresponds to 27% of the density of quartz glass, a density variation in the axial direction of less than +/−8.0% means that the maximal density value can be 29.16% of the density of quartz glass and the minimal density value can be 24.84% of the density of quartz glass. Particularly preferably, the density variation in the axial direction should be less than +/−4.0% of the mean density of the second test soot body.

Moreover, the axial density distribution of the second test soot body should be made more homogeneous to the degree that the mean density change of the second test soot body in the axial direction over 100 mm of length of the second test soot body preferably is less than 10% of the mean density of the second test soot body. Preferably, the change in mean density of the second test soot body in the axial direction over 100 mm of length of the second test soot body should be less than 5%, in particular less than 3%, of the mean density of the second test soot body.

According to procedural step f), the mass deposition of SiO₂ particles to be deposited on the substrate by the depositing burners is set as a function of the axial mass distribution of the test quartz glass cylinder in appropriate manner such that the mass distribution of vitrified soot bodies produced by the depositing burners is made more homogeneous as compared to the axial mass distribution of the test quartz glass cylinder. The mass distribution of the vitrified test quartz glass cylinder is made more homogeneous if the variation of the external diameter of the entire test quartz glass cylinder in the axial direction preferably is less than 9% of the mean external diameter of the test quartz glass cylinder. This means that variations of the external diameters of the entire test quartz glass cylinder preferably are less than 9% of the mean external diameter of the test quartz glass cylinder. In particular, the variation of the external diameter of the entire test quartz glass cylinder in the axial direction is to be less than 5% of the mean external diameter of the test quartz glass cylinder.

The axial mass distribution of the test quartz glass cylinder can be determined through measuring the axial external diameter profile of the test quartz glass cylinder. The density of the quartz glass cylinder is sufficiently constant such that the external diameter profile of the quartz glass cylinder in the axial direction reflects the axial mass distribution.

In addition, while setting the deposition of mass of SiO₂ particles to be deposited on the substrate by the depositing burners according to procedural step f), the axial density distribution of a soot body to be produced by the depositing burners can be adjusted in addition, whereby the axial density distribution is adjusted as a function of the change of the axial density distribution of the soot body to be produced by the depositing burners that is expected to result from setting the mass deposition.

Setting the mass deposition of SiO₂ particles to be deposited on the substrates by the depositing burners according to procedural step f) is often accompanied by a change in the axial density distribution of the soot body to be produced by means of the depositing burners. For this reason, while setting the mass deposition of SiO₂ particles to be deposited on the substrates by the depositing burners according to procedural step f), it is advantageous to additionally adjust the axial density distribution of a soot body to be produced by the depositing burners in appropriate manner, such that the expected change of the axial density distribution of the soot body to be produced by the depositing burners can be compensated.

In practical applications, characteristic data may be available that may have been determined earlier during the production of a multitude of quartz glass cylinders, whereby a correlation exists between the setting of the mass deposition and the expected ensuing change in the axial density. Accordingly, in one embodiment, the expected change of the axial density distribution can be derived from the characteristic data.

Alternatively, in another embodiment in which no characteristic data have been determined earlier or are known, procedural steps a) to b) can be repeated after procedural step f) is carried out and the axial density distribution of a soot body to be produced by means of the depositing burners can be adjusted as a function of the axial density distribution determined in the repeated procedural step b). Subsequently, procedural steps d) to f) can also be repeated. This can be repeated for any number of times.

In one embodiment, at least two feed media each are preferably supplied to the depositing burners, whereby at least one first feed medium each contains a silicon-containing raw medium.

In one embodiment, the at least two feed media can be supplied to the respective depositing burners in a liquid or a gaseous form.

In one embodiment, in order to set the mass deposition of SiO₂ particles on the substrates according to procedural step f), the amount of the silicon-containing raw medium supplied to each depositing burner in the first feed medium can be set. Setting the amount of the silicon-containing raw medium supplied to each depositing burner in the first feed medium means setting the amount per unit of time of the silicon-containing raw medium supplied to each depositing burner in the first feed medium. Therefore, for example the mass flow or, in the case of a gaseous medium, the volume flow can be set.

Furthermore, setting the amount of the silicon-containing raw medium supplied to each depositing burner in the first feed medium means that the amount of the silicon-containing raw medium supplied to each depositing burner in the first feed medium can be increased or decreased or remain unchanged.

In one embodiment, in order to set the axial density distribution according to procedural step c) and/or to adjust the axial density distribution, the amount of at least one of the respective feed media supplied to the depositing burners can be set. Setting the amount of at least one of the feed media supplied to the respective depositing burners means setting the amount per unit of time of at least one of the feed media supplied to the respective depositing burners. Therefore, for example the supplied mass flow of at least one of the feed media supplied to the respective depositing burners or, if the corresponding feed medium is gaseous, the volume flow of at least one of the feed media supplied to the respective depositing burners can be set.

Setting the amount of at least one of the feed media supplied to the respective depositing burners further means that the amount of at least one of the feed media supplied to the respective depositing burners can be increased or decreased or remain unchanged.

The amount of feed media that is supplied to the respective depositing burners affects, in particular, the temperature of the burner flame of the depositing burners, whereby the temperature affects, in particular, the density of the soot bodies to be produced. Since the amount of at least one supplied feed medium per depositing burner is being set and the depositing burners are arranged next to each other in the axial direction and preferably can be moved back-and-forth in the axial direction, the density of the soot body in the axial direction can be changed.

In one embodiment, in order to set the axial density distribution according to procedural step c), the respective amount of the silicon-containing raw medium supplied to each depositing burner in the first feed medium can be kept constant. Preferably, only the axial density distribution of a second test soot body is to be improved in procedural step c). The mass deposition of SiO₂ particles to be deposited on the substrate by means of the depositing burners shall be kept as constant as possible. Therefore, in order to set the axial density distribution according to procedural step c), the respective amount of the silicon-containing raw medium supplied to each depositing burner in the first feed medium can preferably be kept constant.

In one embodiment, each depositing burner can have not only the first feed medium containing the silicon-containing raw medium supplied to it, but also at least one second feed medium, whereby the second feed medium is a fuel medium, in particular a fuel gas. The fuel medium is preferably combusted in the burner flame of the respective depositing burn.

In one embodiment, each depositing burner can have not only the first and second feed media, but also at least one third feed medium supplied to it, whereby the third feed medium is a support medium, whereby the support medium preferably is an oxidation agent, in particular oxygen.

At least one part of the support medium, which preferably is a support gas, is needed for combusting the fuel medium in the burner flame of the respective depositing burn. At least one part of the first feed medium and/or at least one part of the second feed medium and/or at least one part of the third feed medium can be supplied individually to the respective depositing burn.

Likewise, at least one part of the first feed medium and/or at least one part of the second feed medium and/or at least one part of the third feed medium can be supplied as a mixture to the respective depositing burn.

This means that each of the feed media can be supplied to the respective depositing burners separately or as a mixture, whereby just a part of a feed medium can be mixed with just a part of another feed medium just as well. Likewise, one first part of a feed medium can be supplied directly to the respective depositing burner and the second part of the feed medium can be supplied to the respective depositing burner as a mixture that includes another feed medium.

Accordingly, in one embodiment, for example, the first feed medium containing the silicon-containing raw medium can be mixed with one part of the third feed medium; i.e., a part of the support gas, and supplied as a mixture to the respective depositing burn. The other part of the third feed medium can then be supplied separately to each of the depositing burners. Alternatively, the part can just as well be mixed with the second feed medium; i.e. the fuel medium, before supplying them to the respective burn, and be supplied as a mixture to the respective depositing burn.

In one embodiment, in order to set the density distribution according to procedural step c) and/or to adjust the axial density distribution, the amount of the second and/or third feed medium supplied to each depositing burner can be set. This means that the amount of the second and/or third feed medium to be supplied to each individual depositing burner can be set individually for each depositing burn.

In one embodiment, the at least one fuel medium can contain hydrogen, methane, propane, or butane or natural gas.

In one embodiment, the silicon-containing raw medium preferably belongs to the group of siloxanes or silanes, in particular chlorosilanes. SiCl₄, in particular, can be used as chlorosilane. Polyalkylsiloxane, in particular, can be used as siloxane.

In the scope of the invention, the term polyalkylsiloxane shall encompass both linear and cyclical molecules. However, the silicon-containing raw medium preferably contains D4—also called OMCTS—as its main ingredient. The D3, D4, D5 terminology originates from a terminology introduced by General Electric Inc., in which “D” represents the [(CH3)2Si]—O— group. Accordingly, D3 refers to hexamethylcyclotrisiloxane, D4 to octamethylcyclotetrasiloxane, D5 to decamethylcyclopentasiloxane, and D6 to dodecamethylcyclohexasiloxane. In a preferred variant, D4 is the main component of the silicon-containing raw medium. Accordingly, the fraction of D4 is at least 70% by weight, in particular at least 80% by weight, preferably at least 90% by weight, particularly preferably at least 94% by weight of the silicon-containing raw medium.

In one embodiment, steps b) to c) are carried out at least twice before carrying out steps d) to f). Likewise, in one embodiment, a test soot body can be produced again according to step a) after step f), and steps d) to f) can be carried out again at least a second time.

In one embodiment, in order to determine the density distribution of the first test soot body, the density of the test soot body can be measured using a CT procedure.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIGS. 1a to 1c show a method for producing cylinders made of quartz glass according to an embodiment of the present invention;

FIGS. 2a to 2f show procedural steps a to f of a method according to an embodiment of the present invention;

FIGS. 3a to 3f show procedural steps a to f of an alternative method to FIGS. 2a to f according to an embodiment of the present invention;

FIGS. 4a to 4f show procedural steps a to f of an alternative method according to an embodiment of the present invention;

FIGS. 5a to 5f show procedural steps a to f of another alternative method according to an embodiment of the present invention; and

FIGS. 6a to 6f show procedural steps a to f of another alternative method according to an embodiment of the present invention.

### DETAILED DESCRIPTION OF THE INVENTION

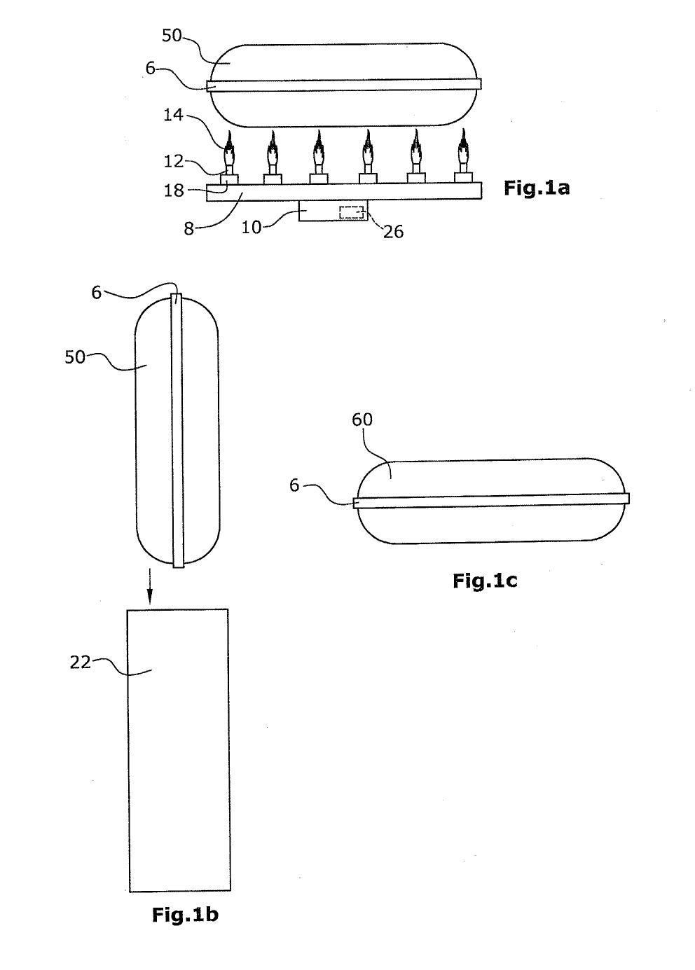

FIGS. 1a to 1c show a method for producing cylinders made of quartz glass according to an embodiment of the present invention. It is evident from FIG. 1 that a soot body 50 is produced. Its production involves an outside deposition method using a multitude of depositing burners 12. For this purpose, at least one first feed medium containing a silicon-containing raw medium, a second feed medium, which is a fuel medium, and preferably a third feed medium, which is a support gas, are supplied to the respective burners and SiO₂ particles are deposited on the outside of the rotating substrate 6. In the process, the silicon-containing raw medium is guided to the reaction zones of the depositing burners 12, which consist of the burner flame 14, and then disintegrated through oxidation and/or hydrolysis and/or pyrolysis to form SiO₂ particles that become deposited on the substrate 6 to form the soot body 50.

The soot body 50 is then preferably subjected to a dehydrogenation process that is not shown here. The dehydrogenation of the soot body can be effected through application of a halogen-containing gas. However, this procedural step is optional.

As is evident from FIG. 1b, the soot body 50 is vitrified in a vitrification furnace 22 in the subsequent procedural step. Preferably, the soot body 50 is sintered for vitrification. As shown in FIG. 1c, a cylinder 60 made of quartz glass is thus produced.

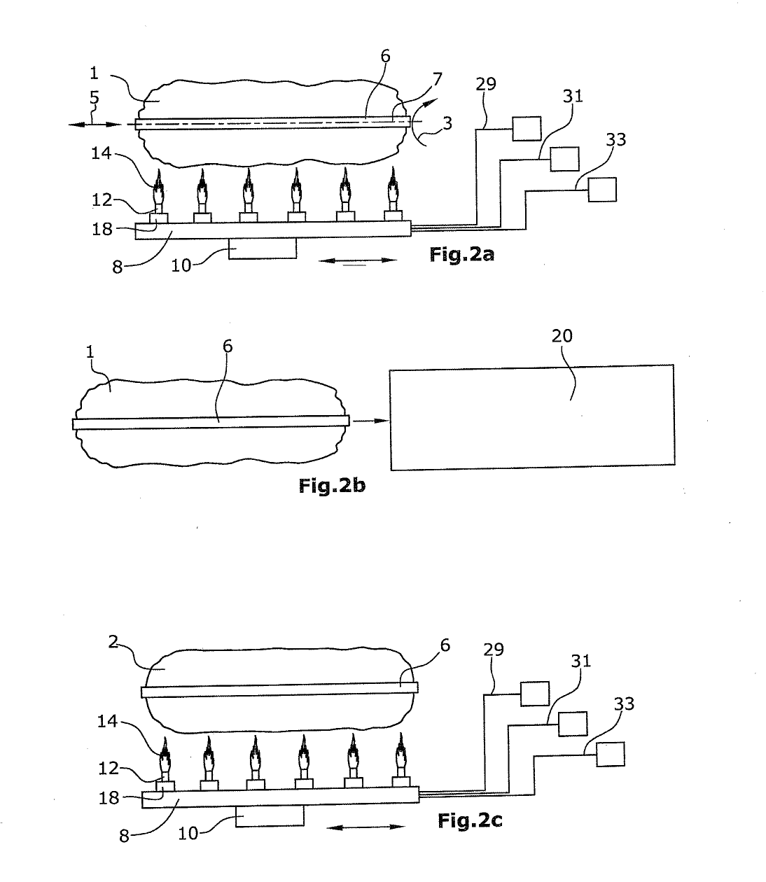

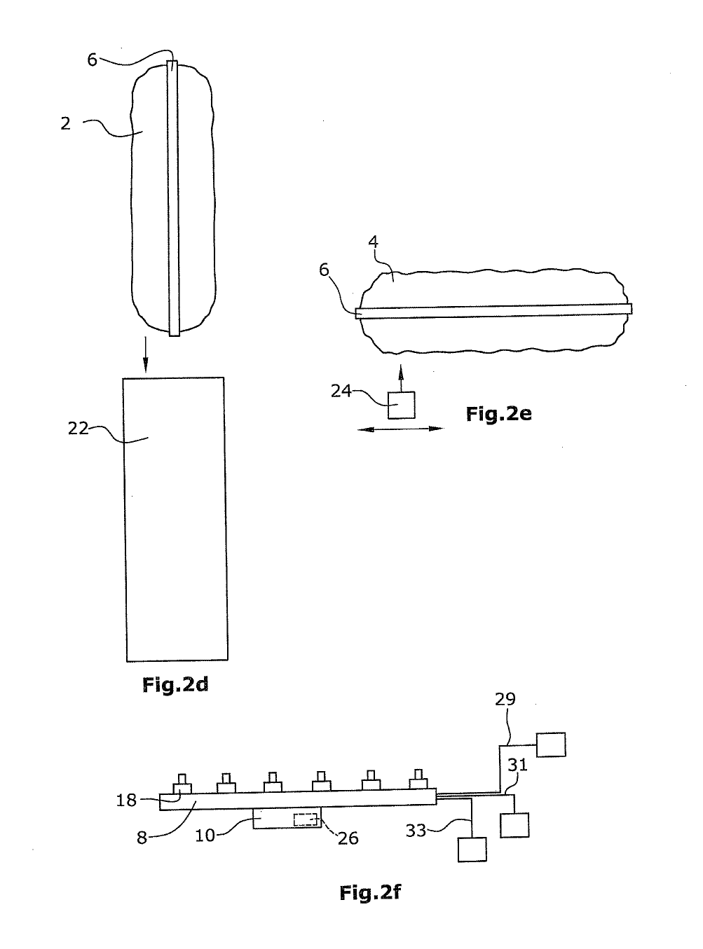

In order to improve the method for producing cylinders made of quartz glass, an iterative method presented in FIGS. 2a to 2f, 3a to 3f, 4a to 4f, and 5a to 5f, is carried out before producing the soot bodies. The iterative method being carried out prior to the production also means that a production process can also be interrupted and the iterative method can then be carried out in order to re-adjust the production method.

FIG. 2a shows procedural step a). A first test soot body 1 is produced, whereby multiple depositing burners 12 are used to deposit SiO₂ particles, for mass deposition, on a substrate 6 that rotates about its longitudinal axis 7. Preferably, the depositing burners 12 are fastened next to each other in the axial direction 5 on a burner holding device 8. Adjacent depositing burners 12 preferably each have an equidistant spacing from each other. The burner holding device 8 can preferably be moved back-and-forth in the axial direction. “In the axial direction” means in a direction that extends parallel to the axis 5 of the first test soot body or parallel to the longitudinal axis 7 of the substrate 6.

A first feed medium 29 containing at least a silicon-containing raw medium, a second feed medium 31, which is a fuel medium, and a third feed medium 33, which is a support gas, are supplied to the burner holding device 8. The first, second, and third feed media, 29, 31, 33 are then supplied to the individual depositing burners 12 within the burner holding device 8. In the case shown, the first, second, and third feed media are supplied separately to the respective depositing burner 12, i.e. separate from each other. The depositing burn 12 can be structured, for example, as described in DE 10 2007 024 725.

In one embodiment, each depositing burner 12 has one setting facility 18 each assigned to it. The setting facility 18 can be used to set for each depositing burner 12 separately the amount of the first, second, and third feed media to be supplied to the individual depositing burner 12. The amount of the feed medium per unit of time is being set in this context. The setting is made using the control facility 10.

The third feed medium, which is a support gas 33, is, in particular, an oxidation agent. Oxygen, in particular, is used as oxidation agent.

The silicon-containing raw medium contained in the first feed medium is disintegrated in the reaction zones of the depositing burners 12, which each consist of the burner flame 14, through oxidation and/or hydrolysis and/or pyrolysis to form SiO₂ particles that become deposited on the substrate 6 to form the first test soot body 1.

The setting facilities 18 of the depositing burners 12 are set appropriately in procedural step a) such that the same amounts of first, second, and third feed media are supplied to all depositing burners 12.

Although the same amounts of first, second, and third feed media are supplied to the depositing burners 12, the burner flames 14 assigned to the respective depositing burners 12 in most cases differ in their temperature, amongst other factors, and/or the silicon-containing raw medium is disintegrated at the individual depositing burners 12 while forming different amounts of SiO₂ particles. The temperatures of the burner flames 14 assigned to the respective depositing burners 12 being different results, for example, in the first test soot body 1 having a different density distribution in the axial direction.

The density distribution in the axial direction of the first test soot body 1 produced according to procedural step a) is determined in procedural step b), which is shown in FIG. 2b. “In the axial direction” means in the axial direction of the soot body and/or quartz glass cylinder.

In FIG. 2b, the axial density distribution of the first test soot body 1 is determined by a CT unit 20. For this purpose, the test soot body 1 is slid into the CT unit 20.

In order to determine the axial density distribution of the first test soot body 1, the density is determined at different levels extending orthogonal to the axis 5 of the first test soot body. Accordingly, the density of the first test soot body 1 is determined at a multitude of levels that are arranged next to each other in the axial direction. This results in the axial density distribution.

A second test soot body 2 is produced in the subsequent procedural step c), whereby the axial density distribution of the second test soot body 2 is set, preferably is made more homogeneous, as a function of the axial density distribution of the first test soot body 1 as determined. This procedural step is shown in FIG. 2c. It is preferable to set the axial density distribution of the second test soot body 2 by setting the amount of at least one of the feed media supplied to the respective depositing burners 12. In the process, the amount of at least one of the supplied media is set separately for each depositing burner 12, whereby the term, “set”, means that the amount of the respective supplied feed medium can be increased or decreased or that the amount can remain constant. It is preferable to set the amount of the first and/or second feed medium supplied to each depositing burner 12, i.e. in the present case, to set the amount of fuel gas and/or oxidation agent supplied to the respective depositing burn.

Since the amount of at least one of the supplied feed media is being set at each depositing burner 12, for example the temperature in the burner flame 14 of the respective depositing burner 12 can be set, which in turn sets the density of the soot body to be produced in the region that can be assigned to the respective depositing burn. At which depositing burner 12 and to which extent to set the first, second, and/or third feed medium can, for example, be determined based on characteristic data from which the correlation between the feed media 29, 31, 33 supplied to the respective depositing burners 12a and the ensuing change of the axial density distribution is evident.

The characteristic data can be produced earlier, e.g. through the production of a multitude of soot bodies by the depositing burners 12 and the first, second, and third feed media 29, 31, 33. These can be produced using the same depositing burners and the same distances of the burners from the substrate 6 and the same burner speed, i.e. velocity of the burners 12 moving back-and-forth. In these investigations, just the amount of the feed media 29, 31, 33 can be re-adjusted and/or set at the respective depositing burners 12, and the ensuing change in the axial density distribution of the soot body produced by the depositing burners 12 can be determined.

In case the silicon-containing raw medium is SiCl₄, it is preferable to set the axial density distribution of the second test soot body 2 through setting the amount of the second feed medium 31, which is the fuel gas, supplied to the respective depositing burners.

The second test soot body 2 comprises an improved, i.e. more homogeneous, axial density distribution as compared to the first test soot body 1.

The second test soot body 2 is vitrified in a procedural step d) that is shown in FIG. 2d. The second test soot body 2 can be subjected to a dehydrogenation process prior to vitrifying the second test soot body 2.

As shown in FIG. 2d, the second test soot body 2 is introduced into a furnace 22 for vitrification. It is preferable to introduce the test soot body 2 into the furnace 22 in vertical direction. It is preferable for the second test soot body 2 to be sintered during vitrification in the furnace. Vitrification can be associated with a change in the axial mass distribution of the vitrified test soot body 2, i.e of the test quartz glass cylinder 4, in particular due to the second test soot body being arranged vertically.

The mass distribution of the test quartz glass cylinder 4 in the axial direction is determined in a procedural step e). As shown in FIG. 2e, a measuring facility 24 is guided in the axial direction along the test quartz glass cylinder 4 for this purpose. The external diameter profile of the test quartz glass cylinder 4 is determined in the axial direction by means of the measuring facility 24. The external diameter distribution of the test quartz glass cylinder 4 in the axial direction reflects the mass distribution in the axial direction since the density of quartz glass is quite constant.

In one embodiment, with regard to the axial mass distribution, the test quartz glass cylinder 4 is subdivided into regions, whereby each region has one depositing burner 12 assigned to it such that the mass deposition can be assigned to one depositing burner 12 each during the determination of the mass deposition in the respective regions. For subdivision of the test quartz glass cylinder 4 into regions, the second test soot body 2 can be engraved accordingly such that the regions are already defined in the test soot body 2 by means of engraving. One depositing burner 12 each is assigned to the regions. The engraving remains visible in the test quartz glass cylinder 4 even after vitrification.

According to procedural step f), the mass deposition of SiO₂ particles to be deposited on the substrate 6 through the depositing burners 12 as a function of the axial mass distribution of the test quartz glass cylinder is set in such manner that the mass distribution of vitrified soot bodies produced using the depositing burners 12 is made more homogeneous with respect to the axial mass distribution of the test quartz glass cylinder 4.

In order to set the mass deposition of SiO₂ particles on the substrates according to procedural step f), the amount of the silicon-containing raw medium supplied to each depositing burner 12 in the first feed medium 29 can be set.

In one embodiment, the amount to be set of the silicon-containing raw medium that is supplied to each depositing burner 12 in the first feed medium 29 can be calculated. The amount to be set can be calculated since the originally set amount of the silicon-containing raw medium supplied to each depositing burner 12 in the first feed medium 29 and the resulting mass deposition per depositing burner 12 are known.

Alternatively, in another embodiment, it is feasible in this case as well to make the setting as a function of characteristic data that are determined earlier or are known. The characteristic data can indicate a correlation between the amount of silicon-containing raw medium supplied and the mass deposition, as determined, of a quartz glass cylinder that is vitrified by means of the furnace 22 and has been produced from a soot body that was produced by means of the depositing burners 12.

While setting the deposition of mass of SiO₂ particles to be deposited on the substrate 6 by the depositing burners 12 according to procedural step f), it is preferable to adjust, in addition, the axial density distribution of a soot body to be produced by the depositing burners 12, whereby the axial density distribution is adjusted as a function of the change of the axial density distribution of the soot body to be produced by the depositing burners 12 that is expected due to the mass deposition being set.

While setting the mass deposition of SiO2 particles to be deposited on the substrate by means of the depositing burners 12 according to procedural step f), changing the respective amount of the silicon-containing raw medium that is supplied to each depositing burner in the first feed medium also changes the axial density distribution of a soot body to be produced by the depositing burners 12.

In one embodiment, the expected change of the axial density distribution can also be determined from characteristic data, whereby the characteristic data can be determined earlier through producing a multitude of soot bodies. The characteristic data can be used to determine a correlation between the change in mass deposition of SiO₂ particles to be deposited on the substrate 6 by m the depositing burners 12 and the resulting change in the axial density distribution. In order to adjust the axial density distribution, the amount of at least one feed medium supplied to the respective depositing burners is being set. It is preferable to set the amount of the first and/or second feed medium supplied to each depositing burner 12, i.e. in the present case, to set the amount of fuel gas and/or oxidation agent supplied to the respective depositing burn.

In case the silicon-containing raw medium is SiCl₄, it is preferable for adjusting the axial density distribution to set the amount of the second feed medium 31, which is the fuel medium, in particular the fuel gas, supplied to the respective depositing burners.

In the case shown in FIGS. 2a to 2f, at least one of the first, second, and third feed media is set per depositing burner in order to set the axial density distribution according to procedural step c) and/or in order to adjust the axial density distribution. In addition, in one embodiment, further feed media can also be supplied to the respective depositing burners. These could also be set in order to set the axial density distribution according to procedural step c) and/or for adjusting the axial density distribution. Alternatively, at least one of the additional feed media per depositing burner could be set just for the purpose of setting the axial density distribution according to procedural step c) and/or for adjusting the axial density distribution. In an alternative exemplary embodiment, it is feasible not to supply the third feed medium, which is the oxidation agent. The burner flame could draw its oxygen, for example, from the ambient air.

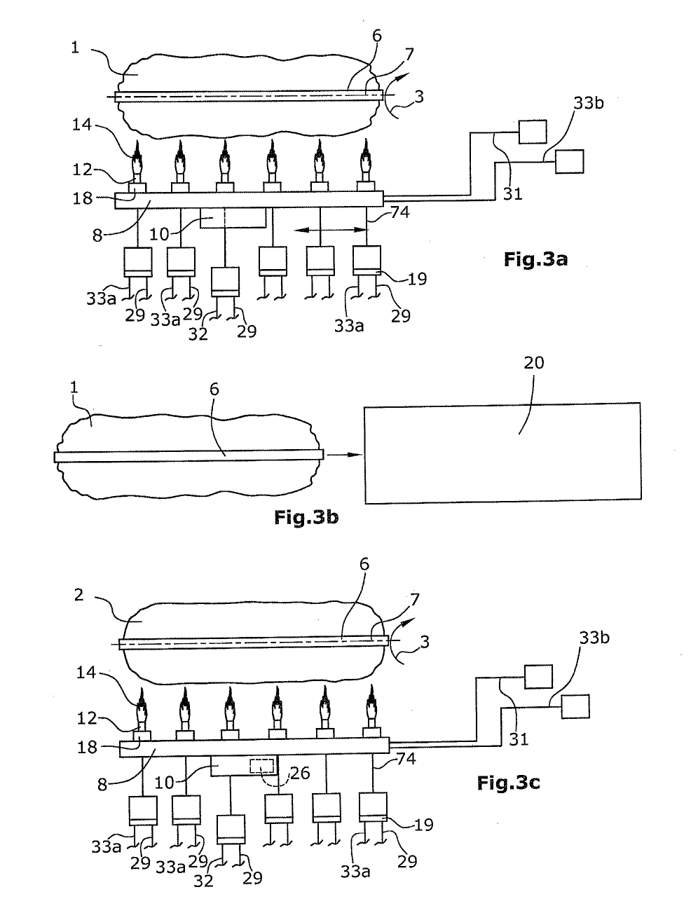

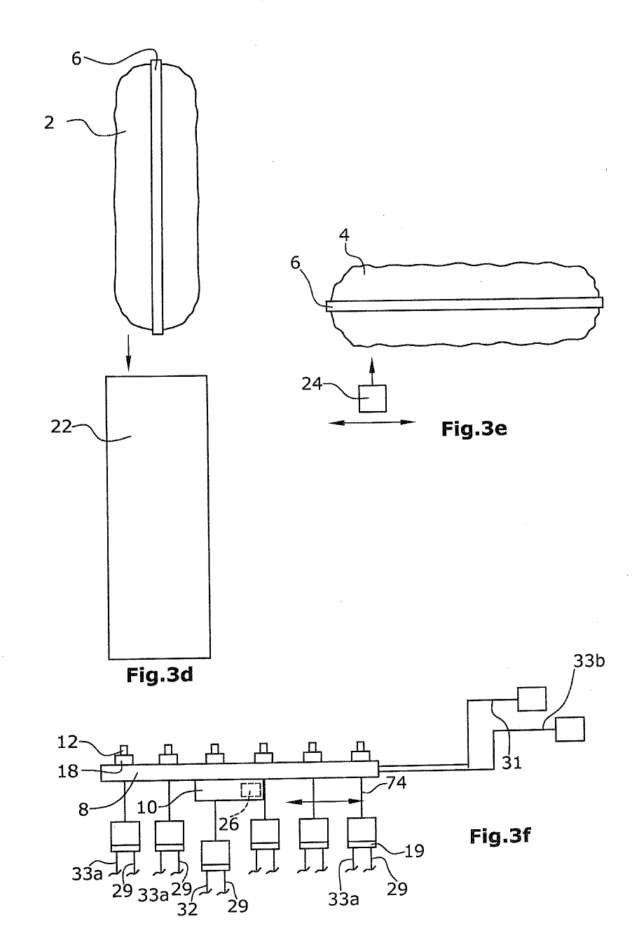

FIGS. 3a to 3f show a method that also comprises procedural steps a to f. The method according to FIGS. 3a to 3f differs only in that the first feed medium 29 and one part of the third feed medium 33a are supplied to the respective depositing burners 12 as a mixture 74, whereby the support medium is an oxidation agent, preferably oxygen. In order to set the axial density distribution according to procedural step c) and/or in order to adjust the axial density distribution, which is done in procedural step f), it is preferred to set the amount of oxidation medium in the mixture 74 that is supplied to the respective depositing burners 12 by a setting facility 19.

In addition, the amount of the second feed medium 31 and second part of the third feed medium 33b that is supplied to the respective depositing burners can be set by the setting facilities 18. Likewise, the amount of the mixture 74 supplied to the respective depositing burners can be set by means of the setting facilities 18. The silicon-containing raw medium preferably is OMCTS in this method.

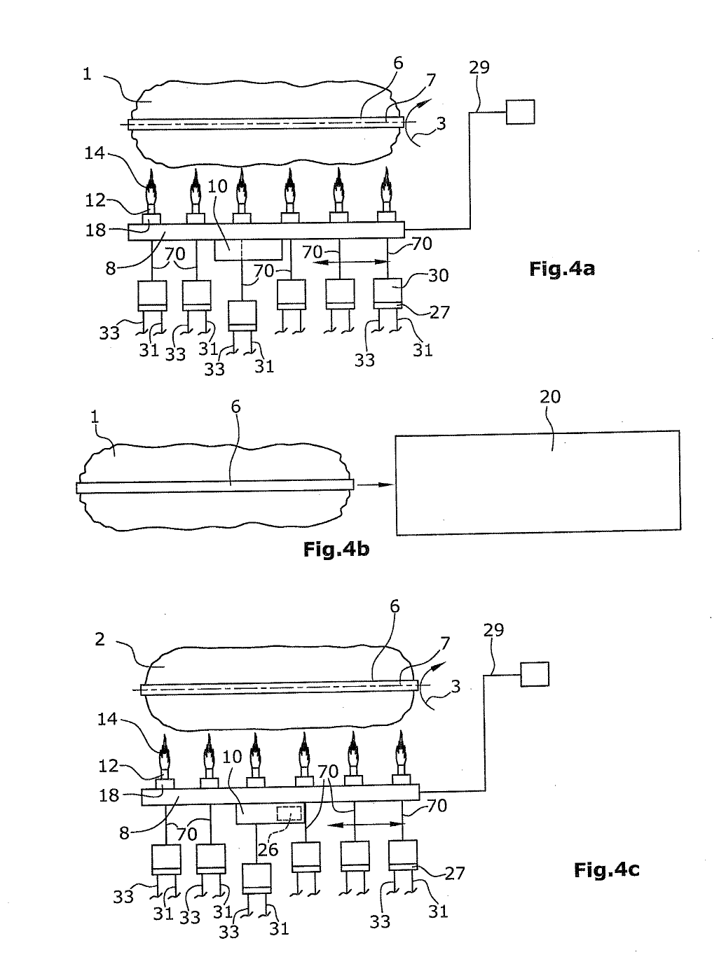

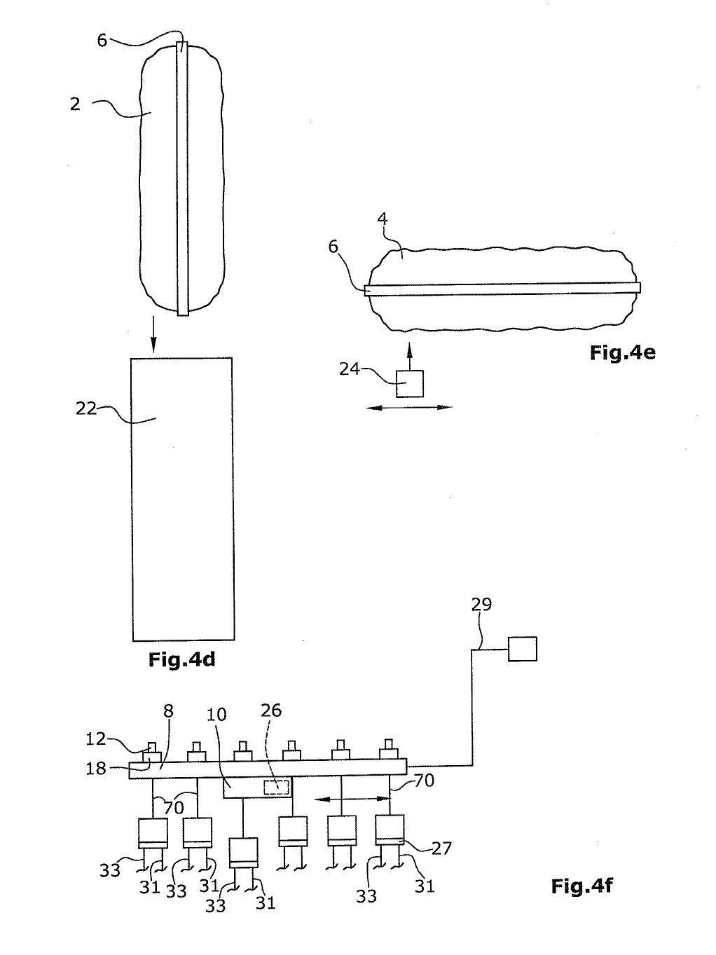

The method shown in FIGS. 4a to 4f strongly resembles the method according to FIGS. 2a to 2f. It differs only in that the second and third feed media are supplied as a mixture to the respective depositing burners 12. In order to set the axial density distribution according to procedural step c) and/or to adjust the axial density distribution, which is done in procedural step f), it is preferred to set the amount of second and/or third feed media 31, 33 in the mixture 70 that is supplied to the respective depositing burner 12 by means of a setting facility 27.

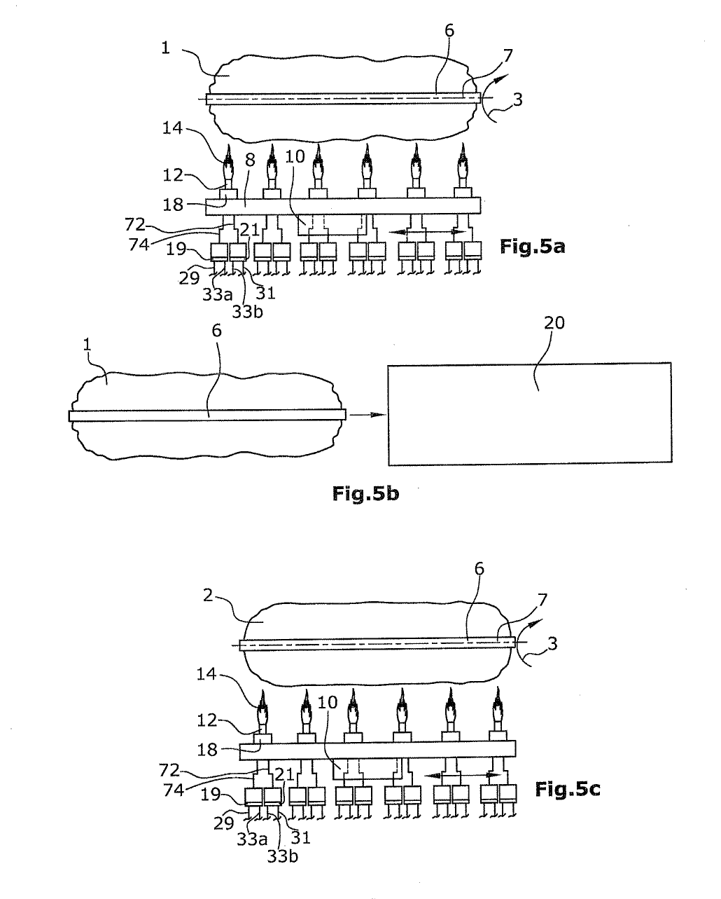

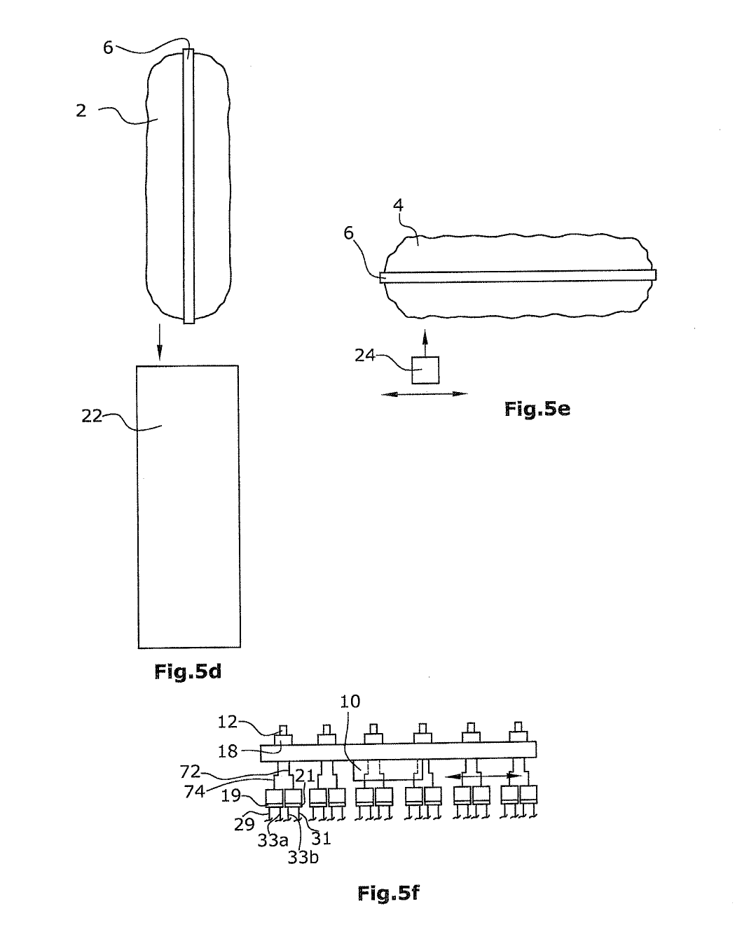

The method shown in FIGS. 5a to 5f strongly resembles the method according to FIGS. 3a to 3f. It differs only in that both the first feed medium 29 and a first part of the third feed medium 33a are supplied as a mixture 74 and the second feed medium 31 and the second part of the third feed medium 33b are supplied as a mixture 72. In order to set the axial density distribution according to procedural step c) and/or to adjust the axial density distribution, which is done in procedural step f), it is preferred to set the amount of the second feed medium 31 and/or first part of the third feed medium 33a and/or second part of the third feed medium 33b that is supplied to the respective depositing burner 12 by means of the setting facilities 19 and 21.

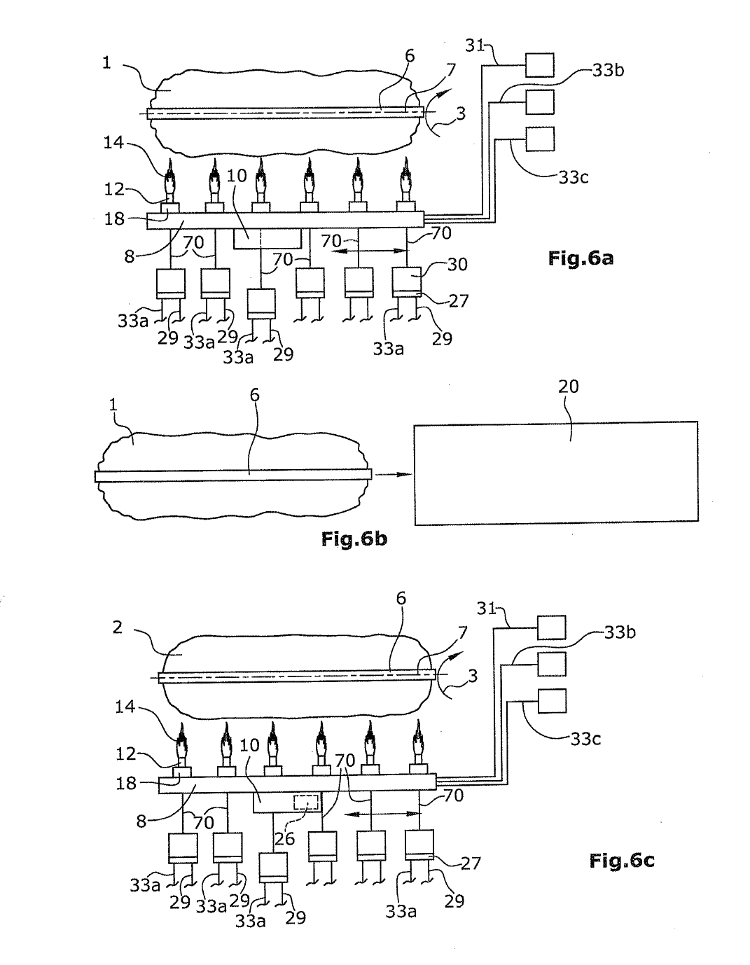

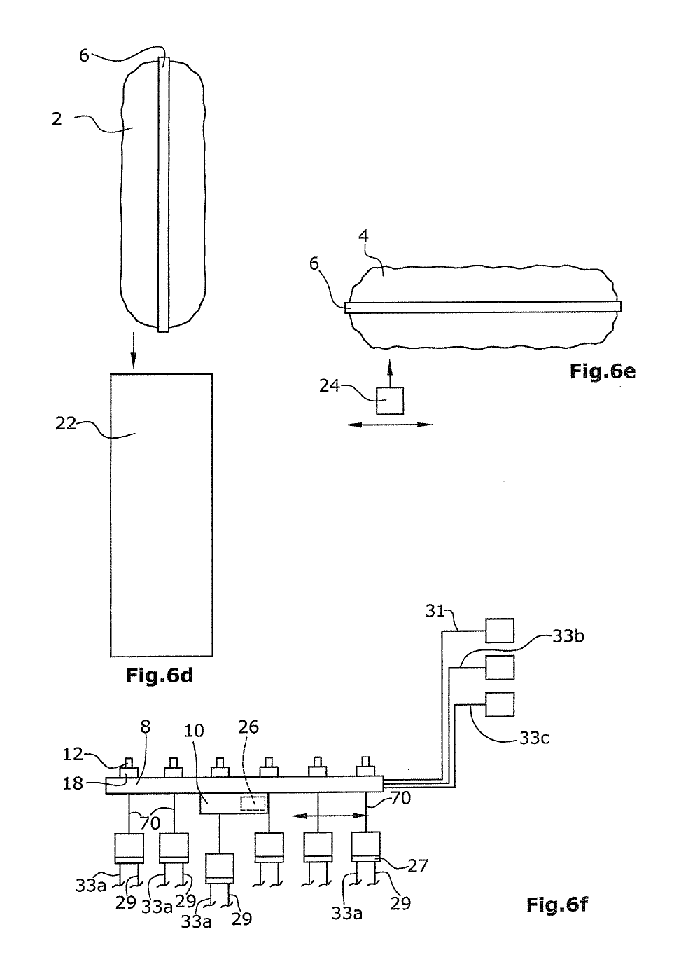

The method shown in FIGS. 6a to 6f resembles the method according to FIGS. 2a to 2f, 3a to 3f, 4a to 4f and/or 5a to 5f. It differs only in that the first feed medium 29 and a first part of the third feed medium 33a are supplied as a mixture to the respective depositing burner 12. The second feed medium 31 and a second part of the third feed medium 33b as well as a third part of the third feed medium 33c are each supplied separately to the respective depositing burner 12. The amounts of the first feed medium 29 and/or second feed medium 31 and/or first part of the third feed medium 33a and/or second part of the third feed medium 33b and/or third part of the third feed medium 33c supplied to the respective depositing burner 12 can be set by means of the setting facilities 18 and/or 27. In case the silicon-containing raw medium is SiCl₄, it is preferable to set the axial density distribution according to procedural step c) and/or to adjust the axial density distribution, which is done in procedural step f), by setting the amount of the second feed medium 31, which is the fuel medium, in particular the fuel gas, supplied to the respective depositing burner 12.

In order to adjust the axial density distribution in an alternative exemplary embodiment, procedural steps a) and b) can be repeated after carrying out procedural step f) and the axial density distribution of a soot body to be produced by the depositing burners 12 can be adjusted as a function of the axial density distribution determined in the repeated procedural step b). This is advantageous in that no characteristic data need to be available from which the correlation between the setting of the mass deposition and the expected change of the axial density distribution is evident. The alternative can be carried out in all methods shown in FIGS. 2a-2f, 3a-3f, 4a-4f, 5a to 5f, and 6a to 6f.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-17. (canceled)

18. A method for producing cylinders made of quartz glass comprising the steps of:
(i) producing soot bodies by using at least two depositing burners to deposit SiO₂ particles for mass deposition on a substrate that rotates about its longitudinal axis;
(ii) vitrifying the soot bodies to form quartz glass cylinders; and
(iii) prior to producing and vitrifying the soot bodies, carrying out the following steps:
a) producing a first test soot body using the at least two depositing burners to deposit SiO₂ particles for mass deposition on the substrate that rotates about its longitudinal axis;
b) determining a density distribution of the first test soot body in an axial direction;
c) producing a second test soot body, an axial density distribution of the second test soot body being set as a function of the axial density distribution of the first test soot body;
d) vitrifying the second test soot body such that a test quartz glass cylinder is generated;
e) determining a mass distribution of the test quartz glass cylinder in an axial direction; and
f) setting the mass deposition of SiO₂ particles to be deposited on the substrate by means of the at least two depositing burners as a function of the axial mass distribution of the test quartz glass cylinder, such that a mass distribution of the vitrified soot bodies produced by the at least two depositing burners is made more homogeneous with respect to the axial mass distribution of the test quartz glass cylinder.

19. The method according to claim 18, wherein, while setting the deposition of mass of SiO₂ particles to be deposited on the substrate by means of the depositing burners according to step f), an axial density distribution of a soot body to be produced by the at least two depositing burners can be adjusted, and wherein the axial density distribution is adjusted as a function of a change of the axial density distribution of the soot body to be produced by the at least two depositing burners that is expected to result from setting the mass deposition.

20. The method according to claim 18, wherein steps a) and b) are repeated after carrying out step f) and wherein an axial density distribution of a soot body to be produced by the at least two depositing burners is adjusted as a function of the axial density distribution determined in the repeated step b).

21. The method according to any claim 1, wherein at least two feed media each are supplied to the at least two depositing burners, at least one first feed medium each containing a silicon-containing raw medium.

22. The method according to claim 21, wherein, in order to set the mass deposition of SiO₂ particles on the substrate according to step f), an amount of the silicon-containing raw medium supplied to each depositing burner in the first feed medium is being set.

23. The method according to claim 21, wherein, in order to set the axial density distribution according to step c) and/or to adjust the axial density distribution, an amount of at least one of the feed media supplied to the respective depositing burner is being set.

24. The method according to claim 23, wherein, in order to set the axial density distribution according to step c), an amount of the silicon-containing raw medium supplied to each depositing burner in the first feed medium is being set.

25. The method according to claim 21, wherein each depositing burner can have not only the first feed medium containing the silicon-containing raw medium supplied to it, but also at least one second feed medium, and wherein the second feed medium contains a fuel medium.

26. The method according to claim 25, wherein each depositing burner can have not only the first and second feed media, but also at least one third feed medium supplied to it, wherein the third feed medium is a support medium; and wherein the support medium is an oxidation agent.

27. The method according to claim 26, wherein at least one part of the first feed medium and/or at least one part of the second feed medium and/or at least one part of the third feed medium is supplied individually to the respective depositing burner.

28. The method according to claim 26, wherein at least one part of the first feed medium and/or at least one part of the second feed medium and/or at least one part of the third feed medium is supplied as a mixture to the respective depositing burner.

29. The method according to claim 26, wherein, in order to set the density distribution according to step c) and/or to adjust the axial density distribution, an amount of the second and/or third feed medium supplied to the respective depositing burner is being set.

30. The method according to claim 25, wherein the at least one fuel medium contains a gas selected from the group consisting of hydrogen, methane, propane, butane and natural gas.

31. The method according to claim 21, wherein the silicon-containing raw medium belongs to the group of siloxanes or silanes.

32. The method according to claim 18, wherein steps b) to c) are carried out at least twice before carrying out steps d) to f).

33. The method according to claim 18, wherein, in order to determine the density distribution of the first test soot body, the density of the first test soot body is measured using a CT procedure.

34. The method according to claim 18, wherein the axial mass distribution of the test quartz glass cylinder is determined through measuring an axial external diameter profile of the test quartz glass cylinder.
